(19) United States
(12) Patent Application Publication
(10) Pub. No.: US 2018/0314309 A1
(43) Pub. Date: Nov. 1, 2018

(54) SMART USB POWER MANAGEMENT

(71) Applicant: LENOVO (SINGAPORE) PTE. LTD., Singapore (SG)

(72) Inventor: Zhongchao Lyu, Tokyo (JP)

(73) Assignee: LENOVO (SINGAPORE) PTE. LTD., Singapore (SG)

(21) Appl. No.: 15/499,749

(22) Filed: Apr. 27, 2017

(51) Int. Cl. G06F 1/32

(52) U.S. Cl. CPC G06F 1/325; G06F 1/3206

(57) ABSTRACT

Methods and apparatus for power management are provided that can adjust power delivery to one or more USB devices based on one or more conditions. A system is provided comprising one or more USB ports, and a processor configured to: detect a change in a power state of the system, wherein at least one USB device is connected to the one or more USB ports; determine whether the change satisfies a condition; and in response to the determining that the change satisfies the condition, cause a power management message to be sent to the at least one USB device that modifies a power consumption of the at least one USB device.

### BACKGROUND OF THE INVENTION

The present invention relates generally to methods and apparatus for power management systems. More particularly, the invention relates to systems for power management that can adjust power delivery to one or more USB devices based on one or more conditions.

An increasing number of portable electronic devices are becoming essential to daily life, such as smartphones, tablets, wearables, health monitors, gaming handhelds, and other devices. Many of these devices can be charged using a standard USB port. Since USB ports are standard peripheral ports on most laptop and tablet computers, users can conveniently charge their portable devices using only their laptop computer, rather than trying to find a free power outlet and charger.

An unfortunate side effect of charging devices on a laptop is the increased system power requirement imposed on the laptop. The battery or AC adapter for the laptop is only rated to provide up to a specified wattage. Since the USB connected rechargeable devices will draw as much current as possible for charging, a significant power load may be imposed. If the laptop is already performing an intensive workload, then the additional USB load may cause the system to exceed its rated wattage.

In a conventional system, a system power management module can only adjust the power consumption of devices internal to the system. As a result, when the rated wattage of the system is exceeded, the system has no choice but to throttle internal devices on the system, such as a CPU and GPU, to reduce power consumption, which may severely impact system performance. Additionally, the increased system load may reduce battery life and increase charging time for a laptop.

Existing power management systems for laptops can adjust system power consumption in some ways, but fail to robustly adapt to the requirements of chargeable USB devices. For example, the Intel Platform Power Monitoring and Control (PSYS) allows the power consumption of the system chipset or system on chip (SoC) to be monitored and kept within a specific platform power limit, but does nothing to adjust the power draw of USB connected devices. USB Power Delivery (PD) has been introduced with USB version 3.0 and allows USB devices to negotiate specific voltage and current levels, but this feature is primarily aimed at devices that need higher voltages and/or current levels to operate, such as large capacity hard disk drives (HDDs), printers, or other high power peripherals. While the GotoMin message of USB PD allows the system to direct USB sink devices to reduce to a minimum operating current, this only provides enough current for minimum operation of the device, excluding any charging. Users expect to be able to charge their USB devices without impacting system performance.

As can be seen, there is a need for a system for power management that can robustly adjust to the demands of chargeable USB devices while maintaining system performance.

### SUMMARY OF THE INVENTION

In one aspect of the present invention, a system is provided comprising one or more USB ports, and a processor configured to: detect a change in a power state of the system, wherein at least one USB device is connected to the one or more USB ports; determine whether the change satisfies a condition; and in response to the determining that the change satisfies the condition, cause a power management message to be sent to the at least one USB device that modifies a power consumption of the at least one USB device.

In another aspect of the present invention, a method for providing smart USB power management is provided, the method comprising: detecting a change in a power state of a system, wherein at least one USB device is connected to the system; determining whether the change satisfies a condition; and in response to the determining that the change satisfies the condition, causing a power management message to be sent to the at least one USB device that modifies a power consumption of the at least one USB device.

In still another aspect of the present invention, a non-transitory computer readable media containing computer readable instructions is provided. When executed by one or more processors, the computer readable instructions cause: detecting a change in a power state of a system, wherein at least one USB device is connected to the system; determining whether the change satisfies a condition; and in response to the determining that the change satisfies the condition, causing a power management message to be sent to the at least one USB device that modifies a power consumption of the at least one USB device.

These and other features, aspects and advantages of the present invention will become better understood with reference to the following drawings, description and claims.

### BRIEF DESCRIPTION OF THE DRAWINGS

FIG. 1A is an overview diagram of a system that uses a system power management module providing smart USB power management, in accordance with an exemplary embodiment of the invention;

FIG. 1B is a schematic block diagram of a system that uses a system power management module providing smart USB power management, in accordance with an exemplary embodiment of the invention;

FIG. 2 is a bar graph that shows exemplary power consumption of a system in different configurations, including a configuration that uses a system power management module providing smart USB power management, in accordance with an exemplary embodiment of the invention; and

FIG. 3 is a flow chart of a method for providing smart USB power management in accordance with an exemplary embodiment of the invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

The present invention relates generally to methods and apparatus for power management systems. More particularly, the invention relates to systems for power management that can adjust power delivery to one or more USB devices based on one or more conditions.

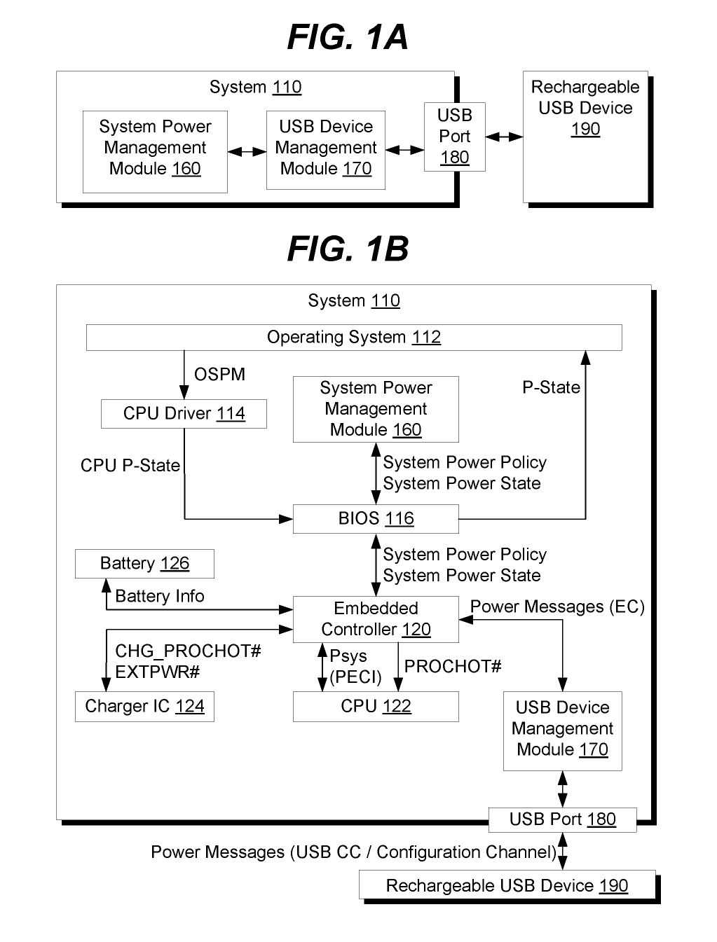

Referring now to FIG. 1A, an overview diagram of a system that uses a system power management module providing smart USB power management is shown. FIG. 1A includes system 110 and rechargeable USB device 190. System 110 may comprise a portable computer such as a laptop, tablet, hybrid convertible, or other form factor. System 110 may include system power management module 160, USB device management module 170, and USB port 180. Embedded controller 120, system power management module 160, and USB device management module 170 may comprise one or more general purpose or customized processors, such as but not limited to an ASIC, FPGA, SoC, or other IC. System 110 is connected to rechargeable USB device 190 via USB port 180. For simplicity, only a single USB port 180 and a single rechargeable USB device 190 is shown; however, it should be understood that system 110 may include multiple USB ports for connection to multiple USB devices and/or one or more USB hubs may be utilized.

The present invention extends the functionality of system power management module 160 such that peripheral devices, such as rechargeable USB device 190, can also be power managed. USB device management module 170 may also be extended to support the translation and sending of power management messages to and from USB devices, such as rechargeable USB device 190. USB device management module 170 may, for example, comprise a standard USB 2.0/3.0/3.1 host controller with power management extensions.

Referring now to FIG. 1B, FIG. 1B is a schematic block diagram of a system that uses a system power management module providing smart USB power management. FIG. 1B includes system 110 and rechargeable USB device 190. System 110 may include operating system 112, CPU driver 114, BIOS 116, embedded controller 120, CPU 122, charger IC 124, battery 126, system power management module 160, USB device management module 170, and USB port 180. With respect to FIG. 1B, like numbered elements may correspond to the same elements from FIG. 1A.

In an embodiment, operating system 112 and BIOS 116 may support ACPI (Advanced Configuration and Power Interface). In this case, operating system 112 may utilize Operating System-directed configuration and Power Management (OSPM) to control power management of various device drivers, such as CPU driver 114. CPU driver 114 may set a CPU power-performance state (CPU P-state) via BIOS 116, which may comprise a UEFI. BIOS 116 may update operating system 112 with a global power state, or P-state, for example if the user puts system 100 into sleep mode, hibernation, or another mode.

System power management module 160 may, for example, comprise a system chipset that is responsible for enforcing a system power policy, which may be received from operating system 112. This system power policy may be relayed to embedded controller 120 via BIOS 116. Embedded controller 120 may monitor the system power state, or the power states of various devices in system 110 including CPU 112, charger IC 124, battery 126, and USB device management module 170. The system power state may be relayed back to system power management module 160 via BIOS 116. System power management module 160 may work with embedded controller 120 to enforce the system power policy based on the present system power state.

As shown in FIG. 1 B, embedded controller 120 can send and receive power related messages to numerous system devices. Embedded controller 120 can read the state of battery 126, for example the remaining battery level. Embedded controller 120 can determine whether charger IC 124 is receiving external power (EXTPWR#), e.g. from an AC adapter, or asserting a signal (CHG_PROCHOT#) to throttle CPU 122, for example if Charger IC 124 detects an overload. Embedded controller 120 can utilize PECI (Platform Environment Control Interface) to determine the thermal load of CPU 122 and to determine the power usage of the system platform (Psys), which includes other system chipset components monitored by embedded controller 120. If necessary, for example to comply with the system power policy, embedded controller 120 may also assert a PROCHOT# signal to CPU 122, causing CPU 122 to throttle to a lower power, reduced performance mode.

Embedded controller 120 may also send and receive power messages to USB management module 170, which may be translated from embedded controller (EC) to configuration channel (CC) format and vice versa when communicating with rechargeable USB device 190. Thus, USB device management module 170 may utilize a USB configuration channel (USB CC) when communicating power messages to and from rechargeable USB device 190. When USB port 180 provides an older connector form factor that does not specify CC pins, then the physical connectors on USB port 180 and rechargeable USB device 190 may be modified to provide CC pins.

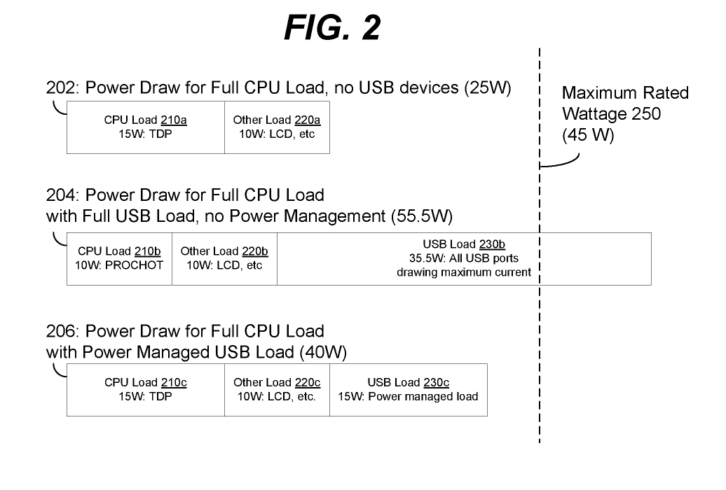

To illustrate the technical problem posed by conventional systems without power management of USB devices, FIG. 2 is a bar graph that shows exemplary power consumption of a system in different configurations. FIG. 2 includes bar 202, bar 204, bar 206 and maximum rated wattage 250. Bar 202 may include CPU load 210a and other load 220a. Bar 204 may include CPU load 210b, other load 220b, and USB load 230b. Bar 206 may include CPU load 210c, other load 220c, and USB load 230c.

Referring to FIG. 2 and FIG. 1 B, bar 202 may correspond to system 110 having a system power state wherein CPU 122 is fully loaded with a real world workload, and thus is operating at its thermal design power (TDP), which may be 15 watts, as reflected by CPU load 210a. Other components of system 110 which are not specifically shown in FIG. 1B, such as a LCD, memory, storage, and other components may consume 10 watts, as reflected by other load 220a. Battery 126 and an external AC adapter may be rated for a maximum of 45 watts, as reflected by maximum rated wattage 250. As shown in FIG. 2, bar 202 has a total power consumption of 25 W, which is a safe margin before reaching the maximum rated wattage 250 (45 W).

Transitioning to bar 204, system 110 may now have several USB devices connected. For example, an exemplary system 110 may provide four USB ports: one (1) high current USB 3.0 port providing up to 2.3 A, two (2) standard USB 3.0 ports providing up to 0.9 A, and one (1) USB Type-C port providing up to 3.0 A. With a voltage of 5V and assuming that each port is occupied by a USB device drawing the maximum possible current from each port, which is easily possible by connecting rechargeable USB devices, then 5V×(2.3+0.9+0.9+3.0 A)=35.5 W is demanded by the USB devices alone, as indicated by USB load 230b. Since other components such as the LCD, memory, and storage may require a minimum amount of power to correctly operate, it may not be possible to reduce other load 220b by a significant amount. As a result, embedded controller 120 may assert a PROCHOT# signal to CPU 122, causing CPU 122 to throttle down to 10 W, as reflected by CPU load 210b. Even after throttling, bar 204 (55.5 W) exceeds the power budget provided by maximum rated wattage 250 (45 W).

Thus, by merely connecting USB devices, the user may unintentionally compromise the performance of system 110. While this can be mitigated by increasing maximum rated wattage 250 to provide a larger power budget, this may not be desirable in many situations. For example, a larger and heavier battery 126 and AC adapter may be necessary to support a larger power budget. Maintaining a lower maximum rated wattage 250 enables system designers to provide highly mobile form factors that are demanded by users.

To avoid the performance degradation described above with bar 204, system power management module 160 is extended to provide power management for USB devices, which is reflected in bar 206. As a result, when USB devices are connected to system 110, system power management module 160 may enforce a system power policy that extends to covers USB devices. For example, a system power policy rule may specify that all USB ports including USB port 180 are to be limited to a predetermined total wattage, for example 15 W as reflected by USB load 230c. However, this rule may unnecessarily restrict USB charging when a large power overhead is available.

As a result, an additional system power policy rule may specify that USB power management only occurs when a power state of system 110 reaches a threshold based on maximum rated wattage 250, for example when a power consumption of system 110 exceeds 80% of the maximum rated wattage 250. As shown by CPU load 210c, CPU 122 can operate at its rated TDP without any throttling, thereby preserving system performance. Other load 220c may remain similar to other load 220b. Thus, bar 206 (40 W) has a safe margin before reaching the maximum rated wattage 250 (45 W). This margin may be used, for example, to allow CPU 122 to boost its frequency clock to provide higher performance when demanded.

To reduce the power load of connected USB devices from 35.5 W to 15 W, power messages may be sent to configure the USB devices into a variety of power modes, such as but not limited to minimum operating power, low power charging, and normal operation (maximum current draw). The low power charging may draw a current that is greater than the minimum operating power but less than normal operation. In some embodiments, a target current draw for the low power charging mode may be specified, allowing system power management module 160 to specify the extent of throttling for USB charging. Accordingly, system power management module 160 can manage power to both system 110 and external USB devices, helping to maintain system performance while meeting the user's expectations that chargeable USB devices will be charged when connected to system 110.

Besides power consumption relative to maximum rated wattage 250, many other conditions may be considered when enforcing system power policy. For example, the user may wish to extend battery life of system 110 as much as possible. In this case, a rule may be added to the system power policy that specifies that when a battery level of battery 126 falls below a threshold value, for example 50% battery level, then USB devices may be power managed to reduce their current draw. This rule may be further modified by only triggering when no external power (e.g. AC power) is available, as indicated by charger IC 124. In this manner, battery life and charging performance of battery 126 may be maintained.

In some situations, the user may instead prefer the opposite result: fast charging of USB devices, even if battery 126 depletes faster or CPU 122 is throttled. For example, the user may need an emergency recharge of several USB devices. In this case, the system power policy may be modified so that the current provided to USB devices is not reduced, regardless of any other rules. Thus, the user may customize the system power policy implemented by system power management module 160 to meet various use cases. For example, a user interface provided by operating system 112 may allow the user to define and customize rules in power profiles that adjust the system power policy.

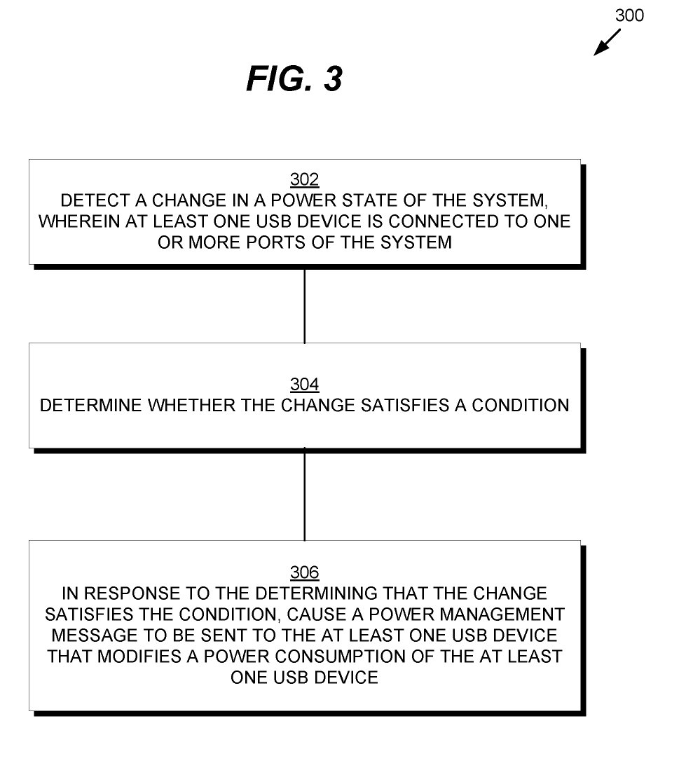

Referring now to FIG. 3, a flow chart illustrates a method 300 for providing smart USB power management. In block 302, system power management module 160 detects a change in a power state of system 110, wherein at least one USB device (rechargeable USB device 190) is connected to one or more USB ports (USB port 180) of system 110. For example, the change may be caused by a user connecting rechargeable USB device 190, which begins drawing current. In another example, the user may launch a demanding application on operating system 112, which causes a load on CPU 122 and a corresponding power consumption increase for system 110. In another example, the user may launch a game application that engages a GPU (not shown), again causing a power consumption increase for system 110. While the above examples illustrate increased power consumption, a decrease in power consumption may also qualify as a change in the power state of system 110.

In block 304, system power management module 160 determines whether the change satisfies a condition. As discussed above, these conditions may be rules that are flexibly defined by a system power policy, and may include limiting a total power consumption of USB ports such as USB port 180, reducing power consumption of USB devices only when the power state of the system reaches a threshold based on maximum rated wattage 250, and reducing power consumption of USB devices when a battery level of battery 126 falls below a threshold value. Of course, these rules are only exemplary.

In block 306, in response to the determining that the change satisfies the condition, system power management module 160 causes a power management message to be sent to rechargeable USB device 190 that modifies a power consumption of rechargeable USB device 190. Rechargeable USB device 190 may thus be configured to accept power messages over USB CC to modify its own power consumption. After the power consumption is thus modified, the condition of block 304 may no longer be satisfied and the system may continue to operate as normal until another change in power state is detected, in which case block 302 of method 300 may start again.

To illustrate an example, assume that the change in power state from block 302 is an increase in total USB port power consumption from 10 watts to 20 watts. Further, assume that the condition of block 304 is that the total wattage of USB devices connected to the USB ports should not exceed 15 watts. System power management module 160 may therefore send a message to embedded controller 120 to reduce the power draw of USB devices by at least 5 watts. Embedded controller 120 may then relay the power message to USB device management module 170.

After receiving the power message from embedded controller 120, USB device management module 170 may then convert the power message into power messages that are formatted for transmission over USB CC. As discussed above, the power messages may specify a minimum operating power, a low power charging mode, and a normal operation mode. When multiple USB devices are connected, the decision on which specific USB devices to throttle and/or the extent of throttling may be carried out by USB device management module 170 and/or system power management module 160. The decision may be based on a device and vendor ID of the USB devices, a present current draw of the USB devices, a connection time of the USB devices, and any other data.

It should be understood that method 300 may be implemented as computer readable instructions that are provided on non-transitory computer readable media, such as a hard disk drive, flash memory, an optical disc, or other media. When executed by one or more processors, the instructions may cause method 300 to be carried out.

It should be understood, of course, that the foregoing relates to exemplary embodiments of the invention and that modifications may be made without departing from the spirit and scope of the invention as set forth in the following claims.

We claim:

1. A system comprising:
one or more USB ports; and
a processor configured to:
detect a change in a power state of the system, wherein at least one USB device is connected to the one or more USB ports;
determine whether the change satisfies a condition; and
in response to the determining that the change satisfies the condition, cause a power management message to be sent to the at least one USB device that modifies a power consumption of the at least one USB device.

2. The system of claim 1, wherein the condition comprises a total power consumption of the one or more USB ports exceeding a predetermined total wattage.

3. The system of claim 1, wherein the condition comprises the power state of the system reaching a threshold based on a rated wattage of the system.

4. The system of claim 1, wherein the condition comprises a battery level of a battery connected to the system falling below a threshold value.

5. The system of claim 1, wherein the power management message instructs the at least one USB device to enter a low power charging state, wherein the power consumption is higher than a minimum operating consumption of the at least one USB device, and wherein the power consumption is lower than a standard charging power consumption of the at least one USB device.

6. The system of claim 1, wherein the power management message instructs the at least one USB device to enter one of a low power operating state and a minimum power operating state.

7. The system of claim 1, wherein the power management message is sent using a USB configuration channel (USB CC).

8. A method for providing smart USB power management, the method comprising:
detecting a change in a power state of a system, wherein at least one USB device is connected to the system;
determining whether the change satisfies a condition; and
in response to the determining that the change satisfies the condition, causing a power management message to be sent to the at least one USB device that modifies a power consumption of the at least one USB device;
wherein the power management message instructs the at least one USB device to enter a low power charging state.

9. The method of claim 8, wherein the condition comprises a total power consumption of the one or more USB ports exceeding a predetermined total wattage.

10. The method of claim 8, wherein the condition comprises the power state of the system reaching a threshold based on a rated wattage of the system.

11. The method of claim 8, wherein the condition comprises a battery level of a battery connected to the system falling below a threshold value.

12. The method of claim 8, wherein the power consumption is higher than a minimum operating consumption of the at least one USB device, and wherein the power consumption is lower than a standard charging power consumption of the at least one USB device.

13. The method of claim 8, wherein the power management message is sent using a USB configuration channel (USB CC).

14. A non-transitory computer readable media containing computer readable instructions that, when executed by one or more processors, causes:
detecting a change in a power state of a system, wherein at least one USB device is connected to the system;
determining whether the change triggers one or more system power policy rules; and
in response to the determining that the change triggers the one or more system power policy rules, causing a power management message to be sent to the at least one USB device that modifies a power consumption of the at least one USB device.

15. The non-transitory computer readable media of claim 14, wherein the one or more system power policy rules includes a rule that limits a total power consumption of the one or more USB ports to a predetermined total wattage.

16. The non-transitory computer readable media of claim 14, wherein the one or more system power policy rules includes a rule that reduces the power consumption of the at least one USB device only when the power state of the system reaches a threshold based on a rated wattage of the system.

17. The non-transitory computer readable media of claim 14, wherein the one or more system power policy rules includes a rule that reduces the power consumption of the at least one USB device when a battery level of a battery connected to the system falls below a threshold value.

18. The non-transitory computer readable media of claim 14, wherein the power management message instructs the at least one USB device to enter a low power charging state, wherein the power consumption is higher than a minimum operating consumption of the at least one USB device, and wherein the power consumption is lower than a standard charging power consumption of the at least one USB device.

19. The non-transitory computer readable media of claim 14, wherein the power management message instructs the at least one USB device to enter one of a low power operating state and a minimum power operating state.

20. The non-transitory computer readable media of claim 14, wherein the power management message is sent using a USB configuration channel (USB CC).
